(19) United States
(12) Patent Application Publication
(10) Pub. No.: US 2012/0234337 A1
(43) Pub. Date: Sep. 20, 2012

(54) HAIR CUTTING DEVICE

(76) Inventor: Mai Bandonis, Honolulu, HI (US)

(21) Appl. No.: 13/439,214

(22) Filed: Apr. 4, 2012

Related U.S. Application Data
(63) Continuation of application No. 11/844,144, filed on Aug. 23, 2007, now abandoned.
Application No. 11/844,144 is a continuation of application No. 12/837,752, filed on Jul. 16, 2010.

(51) Int. Cl. A45D 24/36; B26D 3/00

(52) U.S. Cl. 132/200; 132/214

(57) ABSTRACT

A hair cutting device and method for facilitating and enhancing the ability to cut hair. The hair cutting device comprises a first elongated guide member that includes a first surface. The first surface includes a gravity field orientation sensor, to sense angular orientation. The first elongated guide member includes a first end and a second end. The hair cutting device includes a second elongated guide member that includes a first end configured to selectably couple to the first end of the first elongated guide member. The second elongated guide member includes a second end configured to pivotally couple to the second end of the first elongated guide member. The second elongated guide member includes a plate member selectably coupleable between the first and second elongated guide members. The gravity field orientation sensor is rotatably coupled to an exterior surface of the first elongated guide member, and rotates 360 degrees.

### CROSS-REFERENCE TO RELATED APPLICATIONS

This invention claims priority, under 35 U.S.C. §120, to the U.S. Provisional Patent Application No. 60/843,136, by Bandonis, filed on Sep. 8, 2006, which is incorporated by reference herein. This invention also claims priority, under 35 U.S.C. §120, to the U.S. Provisional Patent Application No. 60/919,591, by Bandonis, filed on Mar. 21, 2007, which is incorporated by reference herein. This application is a Continuation Application of, under 35 U.S.C. §121, and claims priority to, under 35 U.S.C. §121, U.S. Non-Provisional application Ser. No. 11/844,144 entitled Hair Cutting Device, by Mai L. Bandonis, filed on Aug. 23, 2007.

### BACKGROUND OF THE INVENTION

1. Field of the Invention

The present invention relates to cutting hair, specifically to a hair cutting device.

2. Description of the Related Art

Cutting hair has become an ever-growing and vastly popular profession. Professional stylists practice countless techniques to provide different hair styles and/or hair patterns to their clients. Professional stylists are consistent and can reproduce a certain style or technique over and over again. However, a professional stylist may charge a premium to provide a professional styling service to their clients. Therefore, many people have tried to cut their own hair at home to reduce the cost of getting their hair cut at an expensive salon. Often, the results are inconsistent and the hair style usually does not turn out how the person wants it to.

Different hair cutting instruments, guides, and devices are frequently used to cut hair at home, by oneself, or at a salon with an experienced hair stylist. These hair cutting accessories provide different devices and methods to create a professional quality hair cut. These accessories may also provide a reproducible and somewhat professional hairstyle. However, many of the hair cutting devices and guides still require a professional eye to correctly produce a straight cut, curved cut, tapered cut, or any other different type of cut or style that requires a certain technique. Some improvements have been made in the field. Examples of references related to the present invention are described below, and the supported teachings of each reference are incorporated by reference herein:

U.S. Pat. No. 7,073,517, issued to Burnette III, discloses a hair cutting guide, for use by a hairdresser in cutting the hair of a person using scissors, having a pair of guide halves that are hinge ably attached and selectively enter an open position and a closed position. Each of the guide halves have a plurality of teeth arranged along its longitudinal edges. The teeth have an inner surface that face the inner surfaces of the teeth in the other guide halve when the guide is in the closed position. Combs extend perpendicularly to the inner surfaces such that hair is extended transversely between the longitudinal edges and is held in place by the combs when the guide is closed. Straight cutting and point cutting is carried out by cutting with the scissors adjacent to the teeth along one of the longitudinal edges when the guide is in the closed position.

U.S. Pat. No. 6,877,230, issued to Tapia, discloses an instrument for cutting hair that comprises a first and second members extending longitudinally in a direction generally perpendicular to a hinge axis of a hinge that connects the two members at proximal ends thereof. Each member has an arm and a leg. The legs have sockets in which blades are received. The arms comprise grip portions for grasping and actuating by a user's hand. During use, the actuation of the arms moves the legs in an arcuate path about the hinge axis similar to jaws on a pair of tongs. The instrument has a closed pinching or clamping position in which the blades meet each other in abutting relation. The method of using the instrument includes selecting blades from a group of tools comprising razor blades, thinning blades and back guards, disposing the selected blades in the sockets of respective legs, separating the legs, placing a lock of hair between the legs, clamping the blades on the lock of hair, and pulling or pushing the blades in a direction along the length of the hair to progressively cut hairs of the lock of hair.

U.S. Pat. No. 6,267,119, issued to Silva, discloses a haircutting guide-comb instrument for use in cutting head hair of a human being and including a pair of elongated legs superimposed over one another to clasp hair of the human being in between said legs with a bias spring engaged about the terminal ends of the legs to urge them in engagement with one another and an anchor at the terminal ends securing the bias springs to both of the elongated legs.

U.S. Pat. No. 6,135,123, issued to Grassi et al., discloses a hair cutting guide comprising an upper clip and a lower clip is disclosed. A pivot pin interconnects the upper and lower clips allowing rotation of the upper and lower clip with respect to each other. A spring is mounted around the pivot pin and engages the upper and lower clips and urges them into engagement with each other. The upper clip includes a toothed ridge and the lower clip includes a groove which mates with the toothed ridge. The lower clip also includes a toothed ridge which mates with a groove in the upper clip.

U.S. Pat. No. 5,954,063, issued to Pomaro, discloses a hair cutting and styling device that includes a semi-rigid inner band member which has a curved generally semi-circular shape and is sized to substantially encircle the head of a user and be retained in place by an elongated strap member attached onto one end of the inner band member. The elongated strap member is formed of a detachable hook and loop fastening material such as VELCRO®, which permits the device to be releasably retained on the head of a person whose hair is being cut and styled. Alternatively, the device inner band member first portion may include a bendable metal strip and the strap portion includes an elastic fabric segment.

U.S. Pat. No. 5,427,122, issued to Hamilton, discloses a hair-cutting guide having two interconnected plate members which align to compress and sandwich hair there between to be cut along an edge of the aligned plate members.

The inventions heretofore known suffer from a number of disadvantages, which include: being inconvenient, being inefficient, being difficult to use, being expensive, being bulky and/or cumbersome, and being limited in application.

What is needed is a hair cutting device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available hair cutting device. Accordingly, the present invention has been developed to provide an easy, convenient, and efficient way to cut hair.

A hair cutting device for facilitating and enhancing the ability to cut hair may comprise a first elongated guide member which may include a first surface. The first elongated guide member may also include a gravity field orientation sensor, to sense angular orientation, which may be disposed on the first surface. The first elongated guide member may include a first end and/or a second end. The hair cutting device may also include a second elongated guide member that may include a first end configured to selectably couple to the first end of the first elongated guide member. The second elongated guide member may include a second end configured to pivotably couple to the second end of the first elongated guide member. The hair cutting device may include a plate member selectably coupleable between the first and/or second elongated guide members. In addition, the gravity field orientation sensor may rotatably couple to an exterior surface of the first elongated guide member. The gravity field orientation sensor may rotate 360 degrees about the top of the first surface of the first elongated guide member.

The second end of the first elongated guide member and/or the second end of the second elongated guide member may pivotably couple together by a coupling mechanism. The first end of the first elongated guide member and/or the first end of the second elongated guide member may selectably couple together by an attachment mechanism. The plate members of the first and/or second elongated guide members may be selectably removable from the elongated guide members. The selectably removable plate member may include teeth, to secure the hair within the first and/or second elongated guide member.

The first elongated guide member and/or the second elongated guide member may provide a straight edge. The first elongated guide member and/or the second elongated guide member may provide a curved edge. The first elongated guide member may further include a second gravity level orientation sensor, that may be coupled to the exterior surface of the first elongated guide member. The second gravity level orientation sensor may be orientated to indicate a status of level when the hair cutting device is oriented at about 45 degrees. The first elongated guide member may include a horizontal level, that may be coupled to the exterior surface of the first elongated guide member. The first elongated guide member may include a vertical level, that may be coupled to the exterior surface of the first elongated guide member. The first elongated guide member and the second elongated guide member may provide a V-shaped edge. The gravity level orientation sensor may be configured to rotate 360 degrees about the exterior surface of the first elongated guide member in 22.5 degree increments. In addition, the gravity field orientation sensor may be a spirit level.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a front perspective view of a hair cutting device, according to one embodiment of the invention;

FIG. 2 is a front perspective view of a hair cutting device, according to one embodiment of the invention;

FIG. 3 is a top perspective view of a hair cutting device, according to one embodiment of the invention;

FIG. 4 is a top plain view of a gravity field orientation sensor of a hair cutting device, according to one embodiment of the invention;

FIG. 5 is a flow chart of a method of cutting hair with a hair cutting device, according to one embodiment of the invention;

FIG. 6 is a front elevational view of a hair cutting device, according to one embodiment of the invention;

FIG. 7 is a front plan view of a hair cutting device, according to one embodiment of the invention;

FIG. 8 is a top perspective view of a plate member of a hair cutting device, according to one embodiment of the invention;

FIG. 9 is a side perspective view of a hair cutting device, according to one embodiment of the invention;

FIG. 10 is a perspective view of a hair cutting device, according to one embodiment of the invention; and

FIG. 11 is a side perspective view of a hair cutting device, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

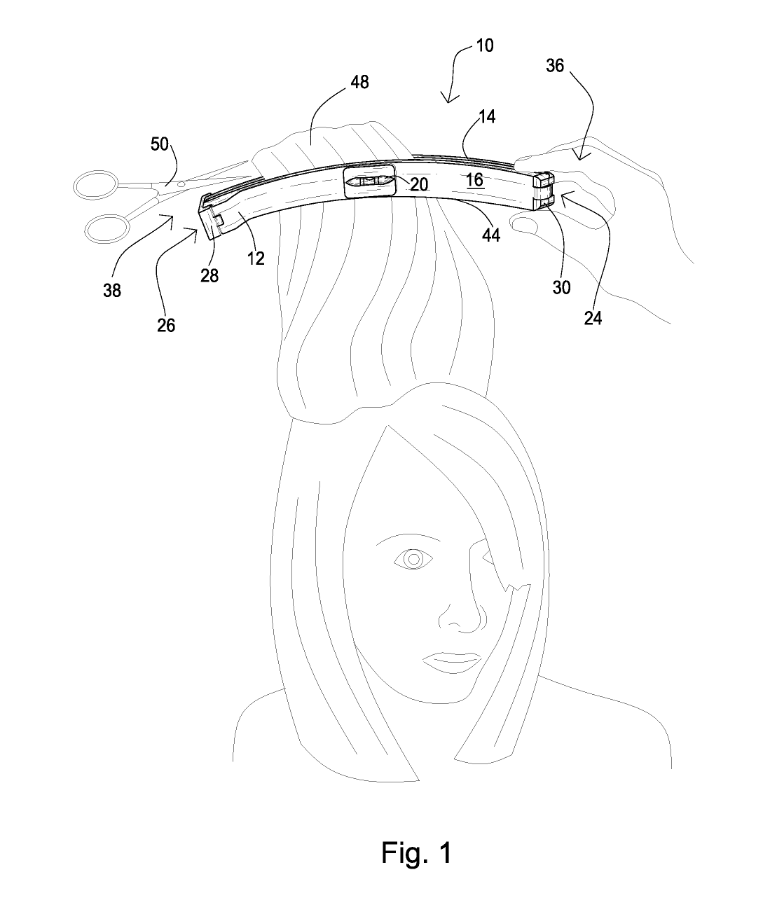

FIG. 1 illustrates a hair cutting device 10 for facilitating and enhancing the ability to cut hair comprising a first elongated guide member 12. The first elongated guide member 12 includes a first surface 16. The first surface 16 includes a gravity field orientation sensor 20 to sense angular orientation. The gravity field orientation sensor 20 is disposed on the first surface 16 of the first elongated guide member 12. One example of a gravity field orientation sensor 20 may be such as, but not limited to, a bubble level as described in U.S. Pat. No. 2,750,677, issued to Wirth, which is incorporated by reference herein for its supported teachings. The first elongated guide member 12 includes a first end 24 and a second end 26. FIG. 1 further illustrates a second elongated guide member 14 that includes a first end 36 configured to selectably couple to the first end 24 of the first elongated guide member 12, by an attachment mechanism 28. One example of a selectably coupleable attachment mechanism 28 may be such as, but not limited to, a snap fastener member as described in U.S. Pat. No. 3,715,783, issued to Parks et al., which is incorporated by reference herein for its supported teachings. The second elongated guide member 14 also includes a second end 38 configured to pivotably couple to the second end 26 of the first elongated guide member 12, by a coupling mechanism 30. One example of a coupling mechanism 30 may be such as, but not limited to, a pin as described in U.S. Pat. No. 1,226,540, issued to Lauletta, which is incorporated by reference herein for its supported teachings.

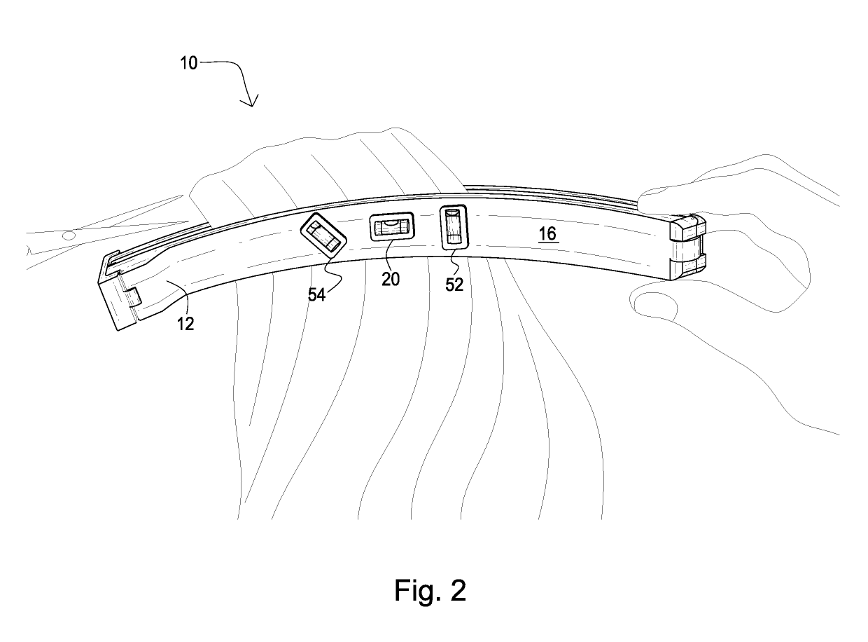

FIG. 2 illustrates a hair cutting device 10 comprising of a first elongated guide member 12 that includes a gravity field orientation sensor 20. The gravity field orientation sensor 20 is disposed on the first surface 16 of the first elongated guide member 12. A vertical gravity field orientation sensor 52 is also disposed on the first surface 16 of the first elongated member 12. In addition, a diagonal gravity field orientation sensor 54 is also disposed on the first surface 16 of the first elongated guide member 12.

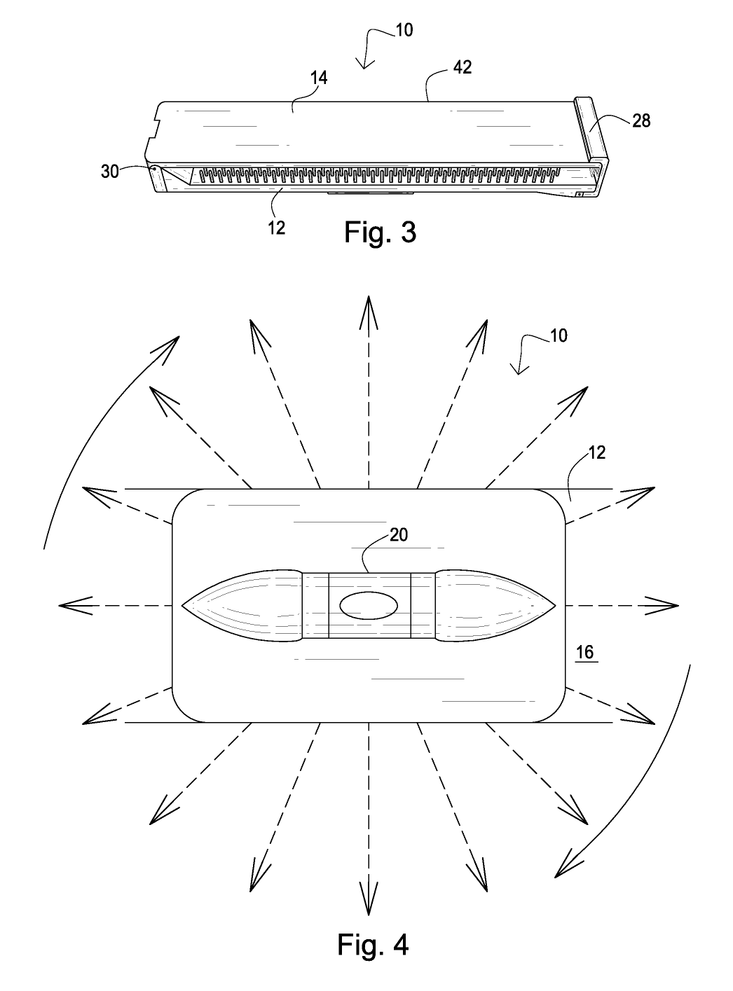

FIG. 3 illustrates a hair cutting device 10 comprised of a first elongated guide member 12 configured to couple to a second elongated guide member 14. The first elongated guide member 12 is coupled to the second elongated guide member 14 by a coupling mechanism 30. A straight edge 42 is configured to the first and second elongated guide members 12, 14. Additionally, the first and second elongated guide members 12, 14 include a selectably coupleable attachment mechanism 28.

FIG. 4 illustrates a gravity field orientation sensor 20 of a hair cutting device 10. The gravity field orientation sensor 20 is disposed on the first surface 16 of the first elongated guide member 12. The gravity field orientation sensor 20 rotates 360 degrees about the first surface 16 of the first elongated guide member 12. The gravity field orientation sensor 20 rotates in 22.5 Degree increments about the first surface 16 of the first elongated guide member 12.

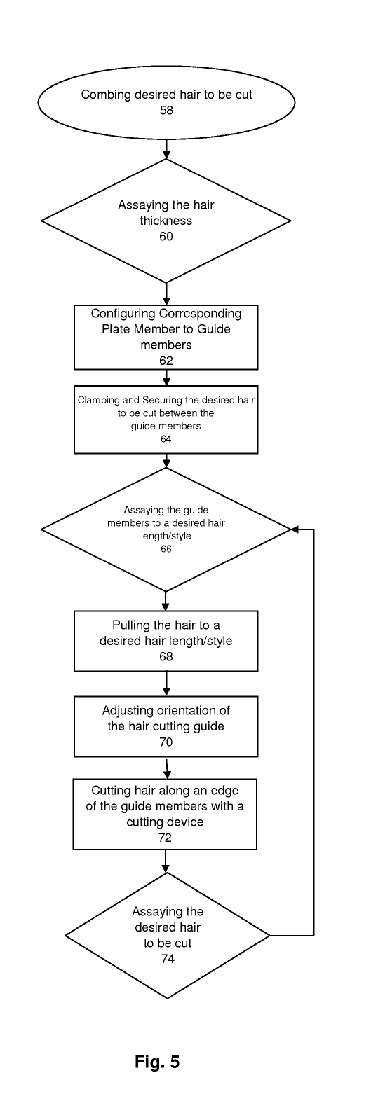

FIG. 5 illustrates a flow chart of a method of cutting hair with the hair cutting device 10. The flow chart diagrams the steps to facilitate and enhance the ability to cut hair using the hair cutting device 10. The flow chart comprises combing the desired hair to be cut 58. In operation of one embodiment of the invention, a user assays the hair's thickness 60 and couples the corresponding plate members to the elongated guide members 62. The user then clamps the hair together and secures the hair between the two elongated guide members 64. Next, the user assays the elongated guide members to a desired hair length/style 66, and pulls the hair cutting device to the desired hair length/style 68. The user adjusts the orientation of the hair cutting guide 70, corresponding to the gravity field orientation sensor 20. The user then cuts the hair along the edge of the hair cutting device 72, and continues the last two steps to assay the hair to the desired hair length/style until the hair cutting is finished 74.

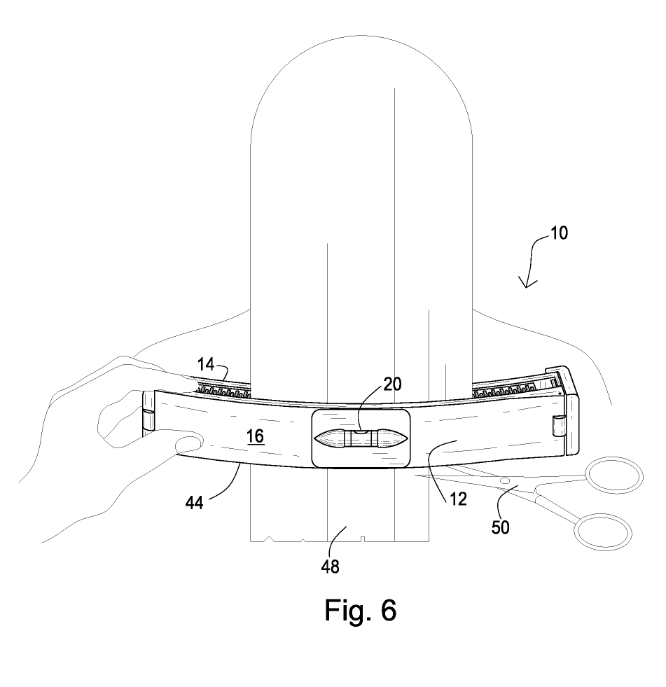

FIG. 6 illustrates a hair cutting device 10 comprising a first elongated guide member 12. The first elongated guide member 12 includes a gravity field orientation sensor 20 disposed on a first surface 16 of the first elongated guide member 12. A cutting device 50 cuts the desired hair 48 to be cut along a curved edge 44 of the guide members 12, 14 of the hair cutting device 10. The hair cutting device 10 is assayed to an orientation corresponding to a desired hair length/style.

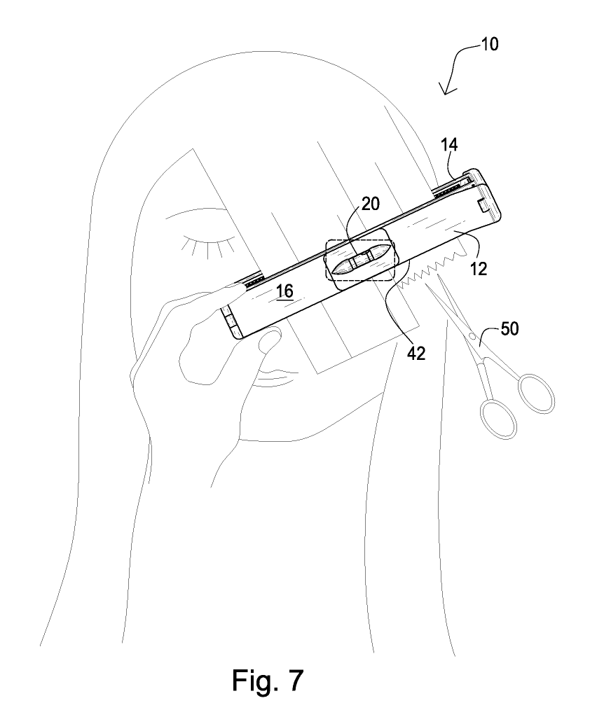

FIG. 7 illustrates a hair cutting device 10 comprising a first elongated guide member 12. The first elongated guide member 12 includes a gravity field orientation sensor 20, disposed on the first surface 16 of the first elongated guide member 12. The gravity field orientation sensor 20 is adjustable to a degree to cut a desired hair length/style. A straight edge 42 is configured to the first and second elongated guide members 12, 14. A cutting device 50 is configured to cut along the straight edge 42 of the elongated guide members 12, 14.

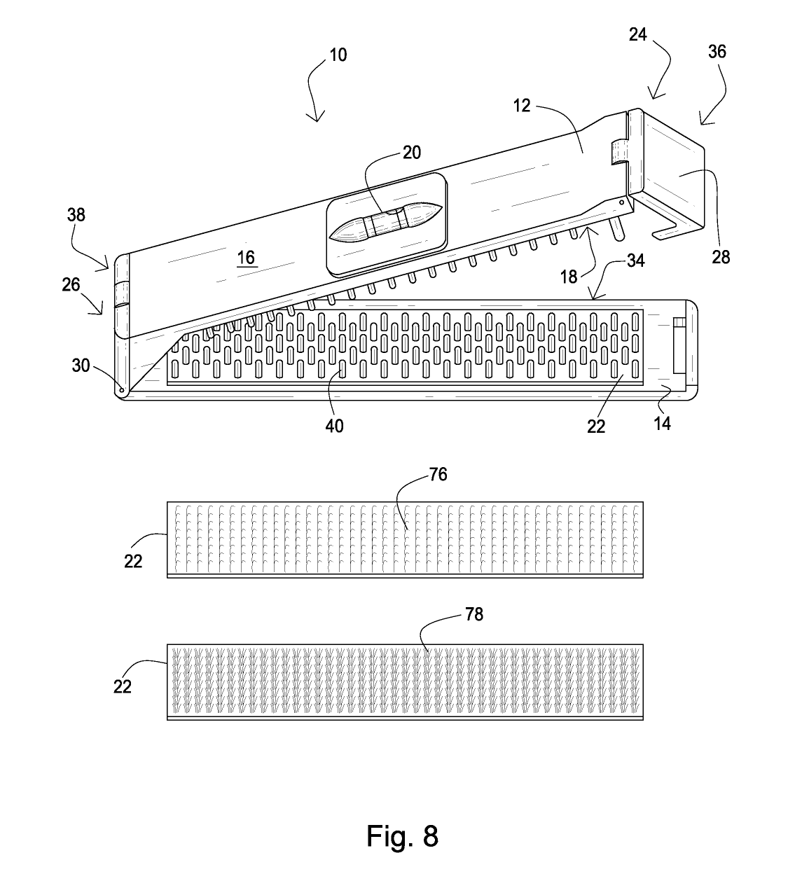

FIG. 8 illustrates a hair cutting device 10 comprised of a selectably coupleable plate member 22 coupled to the second surface of the first and second elongated guide member 18, 34. The plate member includes teeth 40 to secure the hair cutting device 10. The selectably plate member 22 slides into the tongue and groove of the second surface 34 of the second elongated guide member 14. A gravity field orientation sensor 20 is disposed on the first surface 16 of the first elongated guide member 12. The first and second elongated guide members 12, 14 are coupled by a coupling mechanism 30 disposed on the second end of the guide members 26, 38. An attachment mechanism 28 couples the first end of the first and the second elongated guide members 24, 36 together. Furthermore, FIG. 8 further shows three different selectably coupleable plate members 22 configured to couple to the elongated guide members 12, 14. Teeth 40 are illustrated in one embodiment of the selectably coupleable plate members 22, a dense 78 and a less dense 76 selectably coupleable plate members 22 are also shown.

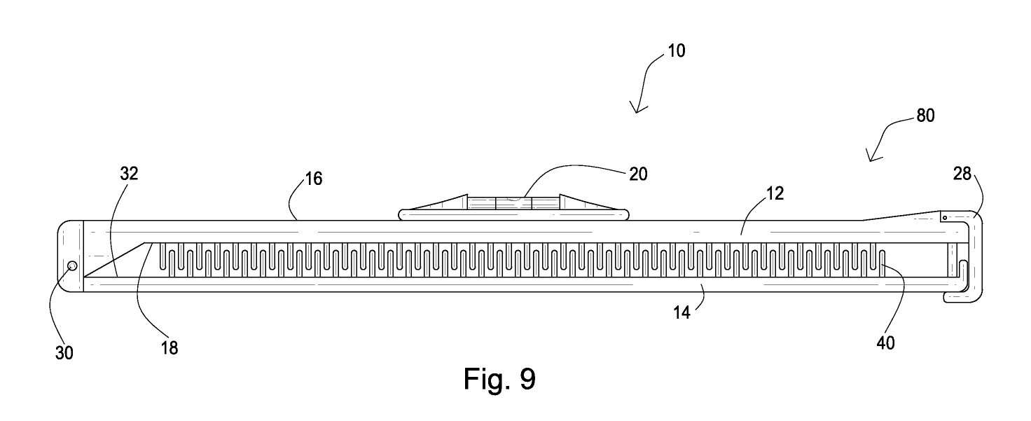

FIG. 9 illustrates a hair cutting device 10 configured in an all in one configuration 80. The configuration 80 includes teeth 40, to secure the hair between the elongated guide members 12, 14, permanently coupled to the second surface 18 of the first elongated guide member 12 and to the first surface 32 of the second elongated guide member 14. The first and second elongated guide members 12, 14 are coupled by a coupling mechanism 30 and selectably coupleable attachment mechanism 28. In addition, a gravity field orientation sensor 20 is configured on the first surface 16 of the first elongated guide member 12.

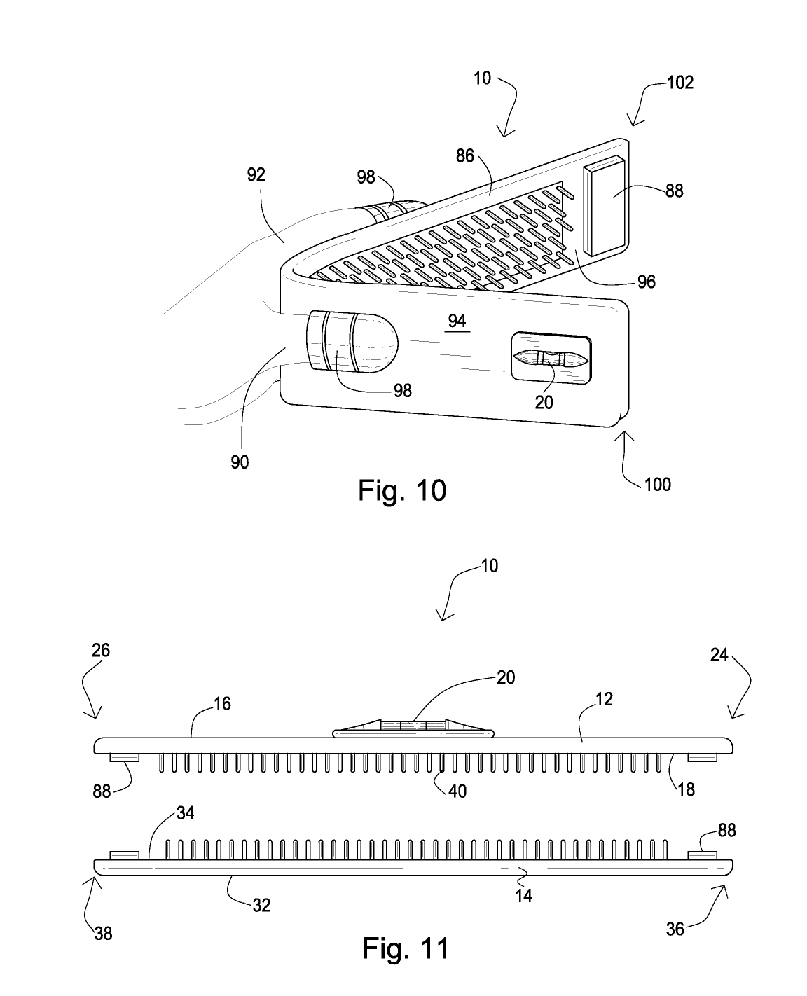

FIG. 10 illustrates another embodiment of a hair cutting device 10 comprising on a single elongated guide member 86. The single elongated guide member 86 includes teeth 40 disposed on a second surface 96 of the single elongated guide member 86. In addition, the single elongated guide member 86 includes a gravity field orientation sensor 20 disposed on a first surface 94 of the single elongated guide member 86. The first surface 94 also includes pockets 98 to dispose a finger 92 and a thumb 94 of the user of the hair cutting device 10. The single elongated guide member 86 includes a first end 100 and a second end 102. The first end 100 is attached to the second end 102 of the single elongated guide member 86 by magnets 88.

FIG. 11 illustrates a hair cutting device 10 comprising a first elongated guide member and 12 a second elongated guide member 14. The elongated guide members 12, 14 are configured to include teeth 40. The teeth 40 are disposed on a second surface of the first and second elongated guide members 18, 34. The first elongated guide member 12 includes a gravity field orientation sensor 20 disposed on a first surface 16 of the first elongated guide member 12. The elongated guide members 12, 14 include a first end 24, 36 and a second end 26, 38. The first ends 24, 36 are configured to couple to each other by an attachment mechanism 28, the attachment mechanism 28 may be such as, but not limited to a magnet 88. The second ends 26, 38 of the elongated guide members 12, 14 are configured to couple to each other by an attachment mechanism 28, the attachment mechanism 28 may be such as, but not limited to a magnet 88. The elongated guide members 12, 14 may be configured with a straight edge 42.

In operation of one embodiment of the hair cutting device 10, the user combs the desired hair to be cut 58. The user then assays the hair's thickness 60; the hair's thickness correlates to a corresponding plate member 62. The plate members may vary according to the variety of hair thicknesses. Next, the user couples the selectably coupleable plate members to the elongated guide members 62. The user then clamps the hair together between the first and second guide members 64. Then, the user assays the elongated guide members to a desired hair length/style 66. The user then pulls the elongated guide members to the desired hair length/style 68. The user may assay the gravity field orientation sensor to a desired hair length/style, adjusting the gravity field orientation sensor to a desired angle/degree corresponding to a desired hair length/style 70. The user then cuts the desired hair to be cut along the elongated guide members 72. The following steps may be repeated until the desired hair/style is finished 74.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate an elongated guide member, one skilled in the art would appreciate that the guide member may vary in size, shape, color, configuration, design, length, width, thickness, orientation and still perform their intended function.

Additionally, although the figures illustrate an attachment mechanism and a coupling mechanism, one skilled in the art would appreciate that the attachment and coupling mechanisms may vary in size, shape, color, configuration, design, length, width, thickness, orientation and still perform their intended function. Moreover, examples of an attachment and/or coupling mechanism may be such as, but not limited to: pins, snaps, hooks, hook and loops, adhesives, magnets, etc. and still perform their intended functions.

In addition, although the figures illustrate a 22.5 degree increment adjustment, one skilled in the art would appreciate that the degree increment adjustment may be such as, but not limited to: 10, 15, 30 degree increment adjustments and still perform its intended function.

Furthermore, although the figures illustrate a pair of scissors as a cutting device, one skilled in the art would appreciate that the cutting device may vary and still perform its intended function. For example, the cutting device may be such as, but not limited to: scissors, clippers, razor blades, etc.

It is also envisioned that one skilled in the art would appreciate that the plate members of the hair cutting device may vary in size, shape, color, configuration, design, length, width, thickness, orientation and still perform their intended function. In addition, examples of plate member configuration may be such as, but not limited to: bristles, spikes, pegs, teeth, Velcro, etc. and still perform its intended function.

It is expected that there could be numerous variations of the design of this invention. For example, the gravity field orientation sensor of the hair cutting device may vary in size, shape, color, configuration, design, length, width, thickness, orientation and still perform its intended function. In addition, the gravity field orientation sensor may be such as, but not limited to: a bubble level, a mason's level, a carpenter's level, a torpedo level, a post level, a line level, an engineer's precision level, an electronic level, a slip indicator, and/or a clinometer; and still perform its intended function. Furthermore, the oil contained within the gravity field orientation sensor is denser than water and/or spirits normally used in carpentry levelers. The denser oil enables the gravity field orientation sensor to slowly adjust to the movement of the device.

Finally, it is envisioned that the components of the device may be constructed of a variety of materials such as, but not limited to: plastic, metal, metal alloys, plastic composites, metal composites, glass, carbon fiber, and/or wood, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A hair cutting device for facilitating and enhancing the ability to cut hair, comprising:
a) a first elongated guide member, including:
a1) a first surface;
a2) a gravity field orientation sensor, configured to sense angular orientation, disposed on the first surface;
a3) a plate member selectably coupleable to the first elongated guide member;
a4) a first end; and
a5) a second end; and
b) a second elongated guide member, including:
b1) a first end configured to selectably couple to the first end of the first guide member;
b2) a second end configured to pivotably couple to the second end of the first guide member; and
b3) a plate member selectably coupleable to the second elongated guide member.

2. A hair cutting device as in claim 1, wherein the gravity field orientation sensor is rotatably coupled to the first surface of the first elongated guide member.

3. A hair cutting device as in claim 1, wherein the gravity field orientation sensor rotates 360 degrees.

4. A hair cutting device as in claim 1, wherein the second end of the first elongated guide member and the second end of the second elongated guide member are pivotably coupled by a coupling mechanism.

5. A hair cutting device as in claim 1, wherein the first end of the first elongated guide member and the first end of the second elongated guide member are selectably coupled together by an attachment mechanism.

6. A hair cutting device as in claim 1, wherein the plate members of the first and second elongated guide members are selectably removable from the elongated guide members.

7. A hair cutting device as in claim 1, wherein the selectably removable plate member includes teeth configured to secure the hair within the first and second elongated guide member.

8. A hair cutting device as in claim 1, wherein the first elongated guide member and the second elongated guide member includes a straight edge.

9. A hair cutting device as in claim 1, wherein the first elongated guide member and the second elongated guide member includes a curved edge.

10. A hair cutting device as in claim 1, wherein the first elongated guide member further includes a second gravity level orientation sensor, coupled to the first surface of the first elongated guide member and configured to indicate a status of level when the hair cutting device is oriented at about 45 degrees.

11. A hair cutting device as in claim 1, wherein the first elongated guide member includes a horizontal level, coupled to the first surface of the first elongated guide member.

12. A hair cutting device as in claim 1, wherein the first elongated guide member includes a vertical level, coupled to the first surface of the first elongated guide member;

13. A hair cutting device as in claim 1, wherein the first elongated guide member and the second elongated guide member includes a V-shaped edge.

14. A hair cutting device as in claim 1, wherein the leveler is configured to rotate 360 degrees about the first surface of the first elongated guide member in 22.5 degree increments.

15. A hair cutting device as in claim 1, wherein the gravity field orientation sensor is a spirit level.

16. A method of cutting hair using a hair cutting guide, comprising the following steps:
a) combing a desired hair to be cut;
b) assaying hair thickness;
c) selectably coupling a pair of elongated guide members to hair, wherein a pair of plate members, respectively, with hair disposed there between;
d) clamping the hair together between the first guide member and the second guide member;
e) assaying the guide members for a desired hair length;
f) pulling the hair cutting guide to a desired hair length;
g) repeating steps e) and 0 until a desired hair length is obtained;
h) assaying a gravity field orientation sensor coupled to the hair cutting guide to a degree corresponding to the desired hair length;
i) adjusting the orientation of the hair cutting guide towards a desired orientation; and
j) cutting the hair along the edge of the guide members with a cutting device.

17. The method of claim 16, wherein the step of assaying the field orientation sensor includes pulling the hair to the left or right at 45 degree, wherein the elongated guide members are secured at 45 degrees.

18. The method of claim 16, wherein the step of assaying the gravity field orientation sensor includes pulling the hair horizontally upwards, or out vertically, wherein the elongated guide members are secured at the desired hair length.

19. The method of claim 16, wherein the hair cutting guide is linear.

20. The method of claim 16, wherein the hair cutting guide is curved.

21. The method of claim 16, wherein the hair cutting guide is V-shaped.

22. The method of claim 16, wherein the step of adjusting the orientation of the hair cutting guide comprises adjusting the gravity field orientation sensor in 22.5 Degree increments.

23. The method of claim 16, further comprising the step of assaying a second gravity field orientation sensor coupled to the hair cutting guide.
